(19) United States
(12) Patent Application Publication
(10) Pub. No.: US 2008/0126235 A1
(43) Pub. Date: May 29, 2008

(54) Real estate investment vehicle and method

(76) Inventors: Peter Sullivan, Oakland, CA (US); Peter Freeman, Piedmont, CA (US)

Correspondence Address: REED SMITH, LLP, TWO EMBARCADERO CENTER, SUITE 2000, SAN FRANCISCO, CA, 94111, US

(21) Appl. No.: 11/524,552

(22) Filed: Sep. 21, 2006

(51) Int. Cl. G06Q 40/00

(52) U.S. Cl. 705/37

(57) ABSTRACT

An Investment System (Vehicle) invests or holds an ownership interest in real property, receiving income from the property for the benefit of the underlying owners in the Vehicle. The Vehicle offers fractional ownership interests to investors owning real property which are exchanged for an ownership in the Vehicle. Such exchanges obtain deferral of gains from appreciation in the value of the property, which would otherwise be taxable, by complying with the provisions of IRC section 1031. The Vehicle provides investors the ability to execute subsequent exchanges of ownership interests in the Vehicle, at the discretion of the exchanging owner, for a separate replacement property representing a more desirable investment. The Vehicle Sponsor facilitates such subsequent exchanges, via either a replacement investor that acquires the ownership in the Vehicle or by purchasing the exchanging owner's interest. Purchases could be financed using a liquidity facility or line of credit established for such purpose. A method of exchanging property to obtain the benefits of tax deferral of gains is also described.

### BACKGROUND OF THE INVENTION

1. Field of the Invention

The present invention relates generally to real estate investments, and more particularly to an investment vehicle and methods for performing tax-deferred exchanges of investment real estate under 26 U.S.C. § 1031.

2. Description of the Related Art

Real estate represents an attractive investment vehicle for a large group of investors. As used herein, the terms “investment vehicle”, “vehicle” or “investment entity” mean an asset, entity, or method created for the purpose of investing in real estate. The benefits include current income, potential appreciation in value, inflation protection, etc. However, real estate suffers from potential disadvantages as an investment, including a lack of liquidity or ability to readily convert or exchange ownership for more desirable assets. In addition, owners of real estate investment property must manage the property for the benefit of the users or renters, which can be burdensome to the owner.

When property is sold, taxes on the amount of gain or appreciation can be incurred. Such gains and related taxes can be deferred if the provisions of 26 U.S.C. § 1031 (also known as Internal Revenue Code (IRC) Section 1031) are followed, wherein the owner of appreciated property exchanges their ownership for “like-kind” property.

Exchanges in conformance with IRC Section 1031 are subject to various conditions, including time limits of 45 days to identify replacement properties and completing the exchange for the replacement property in 180 days. These limits are often problematic for owners wishing to sell. The owners may have difficulty identifying a desirable replacement property. In addition, the complexity of the transaction and large number of participants can prevent an otherwise qualifying exchange from meeting the deadline.

One type of investment that is available for owners of real estate seeking a sale using a qualifying exchange under IRC Section 1031 to defer gains is to exchange ownership in the property held for an ownership interest in a tenants-in-common (TIC) investment vehicle. This form of exchange was facilitated via IRS Revenue Ruling 2002-22, setting forth the conditions for such exchanges. These conditions include:
1. Tenancy in Common Ownership. Each of the co-owners must hold title to the Property (either directly or through a disregarded entity) as a tenant in common under local law.
2. Number of Co-Owners. The number of co-owners must be limited to no more than 35 persons.
3. No Treatment of Co-Ownership as an Entity. The co-ownership may not file a partnership or corporate tax return, conduct business under a common name, execute an agreement identifying any or all of the co-owners as partners, shareholders, or members of a business entity, or otherwise hold itself out as a partnership or other form of business entity.
4. Co-Ownership Agreement. The co-owners may enter into a limited co-ownership agreement that may run with the land. For example, a co-ownership agreement may provide that a co-owner must offer the co-ownership interest for sale to the other co-owners, the sponsor, or the lessee at fair market value before exercising any right to partition, or that certain actions on behalf of the co-ownership require the vote of co-owners holding more than 50 percent of the undivided interests in the Property.
5. Voting. The co-owners must retain the right to approve the hiring of any manager, the sale or other disposition of the Property, any leases of a portion or all of the Property, or the creation or modification of a blanket lien. Any sale, lease, or re-lease of a portion or all of the Property, any negotiation or renegotiation of indebtedness secured by a blanket lien, the hiring of any manager, or the negotiation of any management contract (or any extension or renewal of such contract) must be by unanimous approval of the co-owners. For all other actions on behalf of the co-ownership, the co-owners may agree to be bound by the vote of those holding more than 50 percent of the undivided interests in the Property.
6. Restrictions on Alienation. In general, each co-owner must have the rights to transfer, partition, and encumber the co-owner's undivided interest in the Property without the agreement or approval of any person. However, restrictions on the right to transfer, partition, or encumber interests in the Property that are required by a lender and that are consistent with customary commercial lending practices are not prohibited. Moreover, the co-owners, the sponsor, or the lessee may have a right of first offer (the right to have the first opportunity to offer to purchase the co-ownership interest) with respect to any co-owner's exercise of the right to transfer the co-ownership interest in the Property. In addition, a co-owner may agree to offer the co-ownership interest for sale to the other co-owners, the sponsor, or the lessee at fair market value (determined as of the time the partition right is exercised) before exercising any right to partition.
7. Sharing Proceeds and Liabilities upon Sale of Property. If the Property is sold, any debt secured by a blanket lien must be satisfied and the remaining sales proceeds must be distributed to the co-owners.
8. Proportionate Sharing of Profits and Losses. Each co-owner must share in all revenues generated by the Property and all costs associated with the Property in proportion to the co-owner's undivided interest in the Property.
9. Proportionate Sharing of Debt. The co-owners must share in any indebtedness secured by a blanket lien in proportion to their undivided interests.
10. Options. A co-owner may issue an option to purchase the co-owner's undivided interest (call option), provided that the exercise price for the call option reflects the fair market value of the Property determined as of the time the option is exercised. A co-owner may not acquire an option to sell the co-owner's undivided interest (put option) to the sponsor, the lessee, another co-owner, or the lender, or any person related to the sponsor, the lessee, another co-owner, or the lender.
11. No Business Activities. The co-owners' activities must be limited to those customarily performed in connection with the maintenance and repair of rental real property.
12. Management and Brokerage Agreements. The co-owners may enter into management or brokerage agreements, which must be renewable no less frequently than annually, with an agent, who may be the sponsor or a co-owner (or any person related to the sponsor or a co-owner), but who may not be a lessee. The determination of any fees paid by the co-ownership to the manager must not depend in whole or in part on the income or profits derived by any person from the Property and may not exceed the fair market value of the manager's services. Any fee paid by the co-ownership to a broker must be comparable to fees paid by unrelated parties to brokers for similar services.
13. Leasing Agreements. All leasing arrangements must be bona fide leases for federal tax purposes. Rents paid by a lessee must reflect the fair market value for the use of the Property. The determination of the amount of the rent must not depend, in whole or in part, on the income or profits derived by any person from the Property leased (other than an amount based on a fixed percentage or percentages of receipts or sales).
14. Loan Agreements. The lender with respect to any debt that encumbers the Property or with respect to any debt incurred to acquire an undivided interest in the Property may not be a related person to any co-owner, the sponsor, the manager, or any lessee of the Property.
15. Payments to Sponsor. Except as otherwise provided in this revenue procedure, the amount of any payment to the sponsor for the acquisition of the co-ownership interest (and the amount of any fees paid to the sponsor for services) must reflect the fair market value of the acquired co-ownership interest (or the services rendered) and may not depend, in whole or in part, on the income or profits derived by any person from the Property.

Investments in TIC vehicles have become quite popular. This approach provides real estate investors access to higher value properties in better locations than they could afford independently. It also increases the supply of properties that represent a qualifying replacement for an exchange in compliance with IRC Section 1031.

However, investments in TIC finds are considered highly illiquid, with limited ability to sell or convert them into cash. A sale would typically subject the seller to income taxes, contrary to the typical intent of the original investment in the TIC fund. There is currently no secondary market for selling such interests, and investors are cautioned to anticipate an inability to control the sale of their ownership. This represents a significant problem for real estate investors considering this form of investment.

In further detail, FIG. 1 is an illustration of a prior art exchange of property for a fractional interest in a commingled vehicle, such as a tenants-in-common ownership. This figure shows a previously known method of exchanging property according to IRC Sec. 1031. A Seller 1 who desires an exchange of real property with Buyer 2, enters into a sale agreement with Buyer for property A, and provides title to the subject property to a Qualified Intermediary (QI) 3. The Qualified Intermediary 3 transfers title to Buyer 2 in exchange for payment of the agreed purchase price. Seller 1, in order to comply with IRC Sec. 1031 providing for a deferral of gain on property A, has 45 days to identify and 180 days to close or complete the acquisition of a replacement property. In this case, the Seller 1 intends to acquire a fractional ownership interest as a tenant-in-common in a separate property.

The separate property, the TIC Property, is acquired by the Sponsor 4 promoting the investment vehicle 5 from the original owner, by paying an agreed purchase price. Title to the TIC Property is held by a special purpose entity, a Tenants-in-common (TIC) vehicle 5, established t own the TIC Property and provide co-ownership shares to investors such as the Seller 1. A portion of the acquisition payment for the TIC Property is financed by a Lender 6, who extends a loan secured by a mortgage on the property. All co-owners in the TIC vehicle are jointly and severally liable for this indebtedness.

Next, the Seller 1 obtains a fractional ownership interest in the TIC Vehicle by arranging for the Qualified Intermediary 3 to transfer the funds representing the proceeds of sale of property A, received from the Buyer 2 and held by the Qualified Intermediary 3, to the TIC Vehicle 5.

Similar types of real estate investment vehicles do not provide an exit strategy for their investors or co-owners, apart from a winding up of the vehicle via sale of the underlying assets, with the proceeds distributed to the co-owners. In addition, the present art of real estate investment vehicles does not provide for a portion of the vehicle to be available for sale to new investors or co-owners after the initial establishment of the vehicle.

As a result, it would be desirable to create an investment vehicle offering the benefits of real estate ownership that allows investors the opportunity to acquire an ownership interest in the vehicle via an exchange of appreciated properties, defer income taxes on the gains on such exchanges under the terms of IRC Section 1031, have an exit strategy for investors providing the flexibility to convert ownership interests in the vehicle to an alternate, a more desirable form of investment including other real estate assets prior to the winding up of the vehicle, and provide for a portion of the vehicle to be available for sale to new investors during the life of the vehicle.

### SUMMARY OF THE INVENTION

In general, the present invention is an investment Vehicle providing financial benefits from real estate ownership to real estate owners. These benefits include the ability to exchange properties that have appreciated in value for an ownership interest in the Vehicle, thereby obtaining tax deferral of gains under IRC section 1031. The Vehicle invests in real estate as its primary asset, offering fractional ownership shares to investors. Participants in the Vehicle may include a Sponsor, Vehicle Investors, Limited Partners, and Lenders.

The Vehicle invests or holds an ownership interest in real property, receiving income from the property for the benefit of the underlying owners in the Vehicle. The real property interest may be a single property, or multiple different properties. The Vehicle offers fractional ownership interests to investors owning real property which are exchanged for an ownership in the Vehicle. Such exchanges obtain deferral of gains from appreciation in the value of the property, which would otherwise be taxable, by complying with the provisions of IRC section 1031. The co-owners have the right to sell, hypothecate, transfer, or encumber, their ownership interests subject to provisions imposed in connection with any credit agreements and a right of first refusal on the part of the other owners of the Vehicle, including the Sponsor. The Vehicle is not necessarily a separate legal entity, and may merely represent the underlying real property, as owned by the fractional co-owners.

The Vehicle provides investors the ability to execute subsequent exchanges of ownership interests in the Vehicle, at the discretion of the exchanging owner, for a separate replacement property representing a more desirable investment. The Vehicle Sponsor facilitates such subsequent exchanges, via either a replacement investor that acquires the ownership in the Vehicle or by purchasing the exchanging owner's interest. Purchases could be financed using a liquidity facility or line of credit established for such purpose.

In a preferred embodiment, a portion of the Vehicle is held for sale to new co-owners throughout the life of the Vehicle.

Ownership of the Vehicle could include two or more classes of investors, such as Vehicle Investors and Limited Partners. Limited Partners, if included, would retain their ownership for the full duration of the Fund, until the underlying property was sold and vehicle was wound up or terminated. Such Limited Partners could share in the income generated by the Fund, including a portion of fees from the sale or exchange of co-ownership interests. This form of ownership participation in the Vehicle by Limited Partners improves the perception of the credit risk associated with the potential turnover of Vehicle Investors' interests, and thus allows the Vehicle and Sponsor to obtain debt financing on more beneficial terms.

The Sponsor of the Vehicle may earn fees from the purchase or initial acquisition of co-ownership interests by investors. The Sponsor could also receive fees from the sale or exchange of the Vehicle Investors' ownership interests, such as for a subsequent replacement property that would qualify for the benefits of tax-deferral of gains under IRC Section 1031.

The value of the ownership interests could be determined periodically based on the current net operating income on the property owned by the Vehicle, capitalized at the rate for similar properties as established by a nationally recognized real estate research institution. Such valuation would be defined in the ownership agreement for the Vehicle. Alternately, these periodic valuations could be determined by appraisals performed by outside professionals commissioned for such purpose.

The Sponsor could provide or cause to be provided on behalf of the tenants in the property owned by the Vehicle services to the property including repairs, maintenance, capital improvements, insurance, payment of taxes, filing of reports and tax returns. The Sponsor could also account for the financial results of the Vehicle and provide reports to the co-owners, lenders, and other outside parties as necessary and appropriate.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is an illustration of a prior art exchange of property for a fractional interest in a commingled vehicle, such as a tenants-in-common ownership;

FIG. 2 is a diagram of an embodiment of the present invention illustrating a general structure of an investment vehicle according to the present invention;

FIGS. 3A-3E illustrate the relationships between the various parties involved in an investment vehicle, consisting of the Sponsor, Vehicle Investors, Limited Partners, and Lender(s);

FIG. 4 is a diagram illustrating the initial acquisition of co-ownership in the Vehicle by a Vehicle Investor;

FIG. 5 is a diagram illustrating the exchange of co-ownership in the Vehicle;

FIG. 6 is a diagram illustrating the possible property management functions provided by the Sponsor;

FIG. 7 is an example of computer system that can implement the management of the Vehicle according to the present invention;

FIG. 8 is a pro form a statement showing a sample project return summary;

FIG. 9 is a pro form a statement showing a sample Vehicle Investor return; and

FIG. 10 is a pro form a statement showing a sample Sponsor's return and distribution of income.

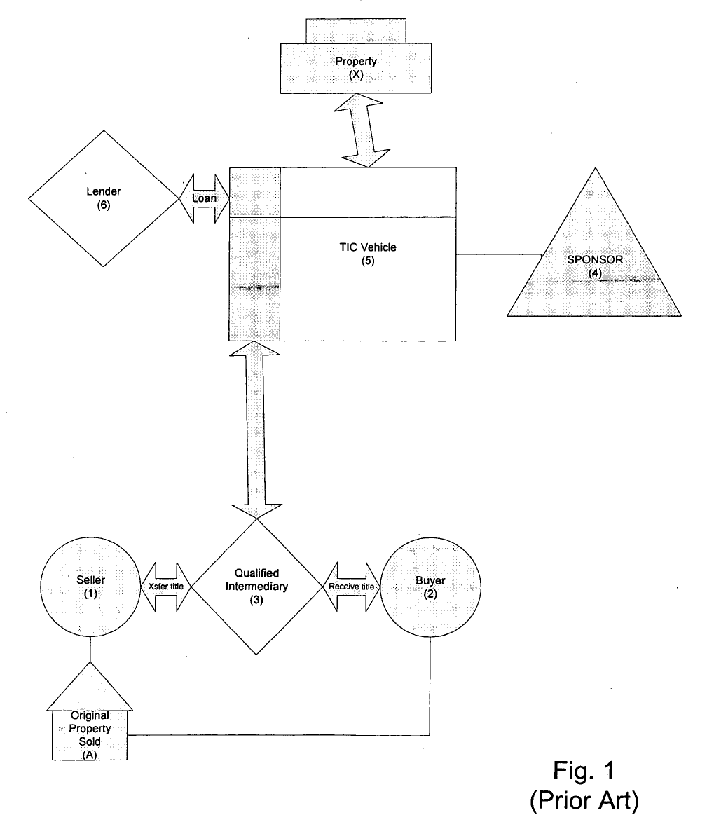

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

In general, the present invention is an investment Vehicle and method that provides financial benefits from real estate ownership to real estate owners. These benefits include the ability to exchange properties that have appreciated in value for an ownership interest in the Vehicle, and obtaining tax deferral of gains under IRC Section 1031. The investment Vehicle invests in real estate as its primary asset, offering fractional ownership shares to investors.

The Vehicle provides investors the ability to execute subsequent exchanges of ownership interests in the vehicle, at the discretion of the exchanging owner, for a separate replacement property representing a more desirable investment. The “Vehicle Sponsor” facilitates such subsequent exchanges, via either a replacement investor that acquires the ownership in the vehicle or by purchasing the exchanging owner's interest. Purchases are financed using a liquidity facility or line of credit established for such purpose. Providing a clearly defined exit strategy is a significant enhancement compared to other real estate investment vehicles currently available.

In one embodiment of the present invention, participants in the Vehicle may include a Vehicle Sponsor, Vehicle Investors, Limited Partners, and lenders. The Vehicle is not necessarily a separate entity apart from the real property interest, and is merely a convenient way of expressing the ownership interest in the underlying real property investment itself.

The Vehicle Sponsor is a party that establishes the Vehicle and provides overall direction and management, including facilitating exchanges in the Vehicle by providing a replacement Vehicle Investor, or by purchasing the interest, utilizing a liquidity facility or line of credit. A portion of the Vehicle may be held for resale to new co-owners or Vehicle Investors during the term of the Vehicle. The Sponsor earns fees from the initial investment in the Vehicle and any subsequent sales or exchanges by Vehicle Investors. The Sponsor accounts for the financial results of the Vehicle and provides reports to the Limited Partners, lenders, and other outside parties as necessary and appropriate. A computer may be used to perform all of the above activities and keep track of each Investor's assets and obligations.

The Vehicle Investors obtain fractional ownership interests in the Vehicle. The Vehicle provides investors the ability to acquire ownership interests via like-kind exchanges, thereby obtaining tax benefits, including deferral of taxes on gains and preservation of the cost basis from the original property. The Vehicle provides an exit strategy by facilitating subsequent sales or exchanges at the discretion of the Vehicle Investor.

Limited Partners may own a fractional portion of the Vehicle, who earn a share of the fees from sales of fractional ownerships. The Vehicle may be financed with a mortgage on the underlying property or properties, with all Investors or Limited Partners liable for the debt. The Vehicle Sponsor obtains a separate line of credit to provide liquidity for repurchase of the Vehicle Investors' interests, pending resale of interests to new investors. Valuation of ownership interests may be established periodically for accounting purposes.

In a preferred embodiment, the Limited Partners retain ownership for the lifetime of the Vehicle, thereby improving the perception of the credit risk associated with the potential turn-over of the other investor's interests. The Limited Partners may earn a share of the fees from sales of fractional ownerships.

Additionally, a set of Vehicles may be established with varying levels of debt financing.

A property manager may be hired who would provide or cause to be provided services including repairs, maintenance, capital improvements, insurance, payment of taxes, filing of reports and tax returns on the underlying real estate.

The Vehicle may comprise a single real property, or multiple underlying real property interests.

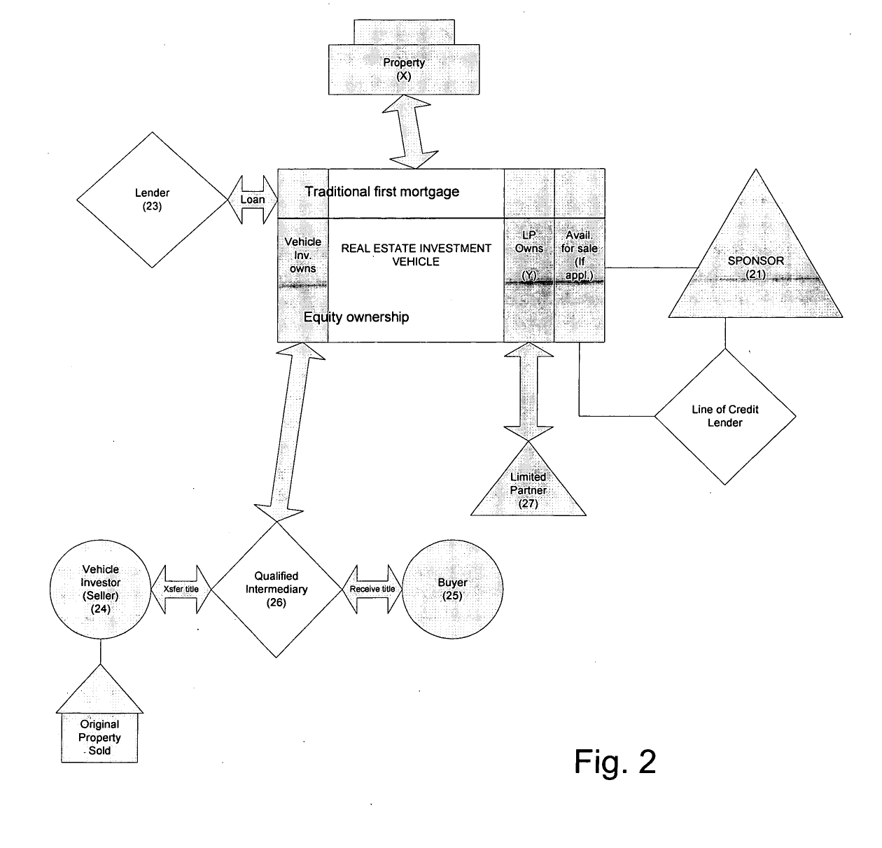

FIG. 2 is a high-level diagram illustrating one embodiment of the present invention. This diagram illustrates the ownership of a property (or properties) under a commingled or combined ownership structure or Vehicle, with several classes of co-owners as tenants-in-common, and subject to debt that partially finances the property. First, a Sponsor 21 acquires a property to provide the underlying asset of the investment opportunity to various classes of investors participating in the investment Vehicle. Title to the property is transferred to the Vehicle. The property is leased on a triple net basis to a high quality, creditworthy tenant 22 on a long term basis. A portion of the acquisition payment for the TIC Property is financed by a Lender 23, who extends a loan secured by a mortgage on the property.

An investor (Vehicle Investor) 24 seeking to exchange an existing real property for a replacement property in order to defer gains, enters into an agreement with a Buyer 25. The Buyer 25 transfers the amount of the agreed purchase price to a Qualified Intermediary 26, in exchange for title to the Seller's property. The Qualified Intermediary 26 transfers the proceeds of the sale of the property received from Buyer 25 to the Vehicle in exchange for a fractional or co-ownership interest, received by the Trading Investor 24. A series of similar co-ownership interests can be obtained from other Trading Investors (not shown).

Similarly, co-ownership interests can be obtained by Limited Partners 27 upon payment of the appropriate amount into the Vehicle. Finally, the Sponsor 21 may also receive or obtain a co-ownership in connection with the establishment of the Vehicle. The Sponsor 21 may also provide property management services in connection with the property owned by the Vehicle.

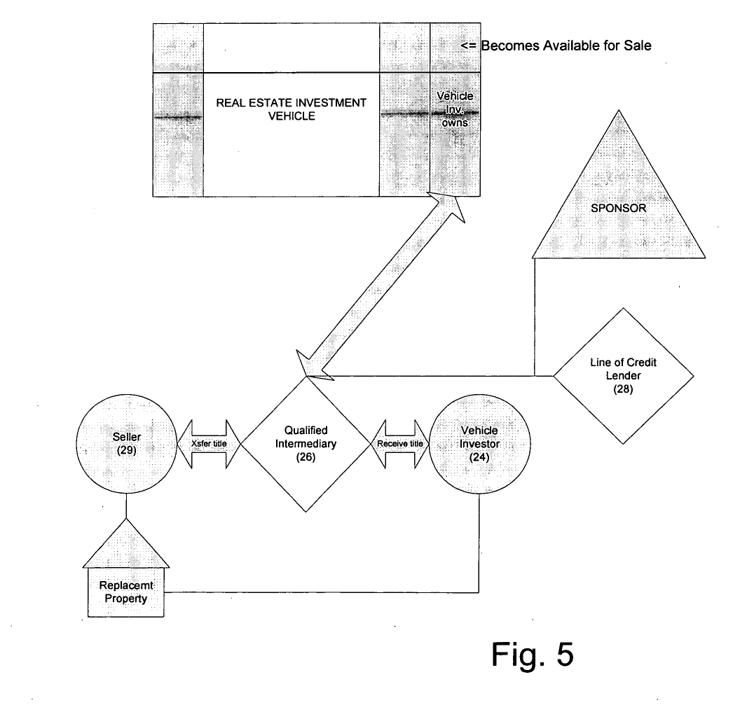

Throughout the term or life of the Vehicle, it is possible that a portion of the ownership in the Vehicle may be held available for sale to new Vehicle Investors. This may include co-ownership interests in the Vehicle exchanged by Vehicle Investors for replacement properties, as described more fully with respect to FIG. 5. Vehicle Sponsor 21 facilitates such exchanges of ownership interests by obtaining replacement investors or by purchasing the exchanging investor's interest. Such ownership interests can be financed under a line of credit established to provide funds to finance or carry the value represented by the ownership interests in the Vehicle held available for sale.

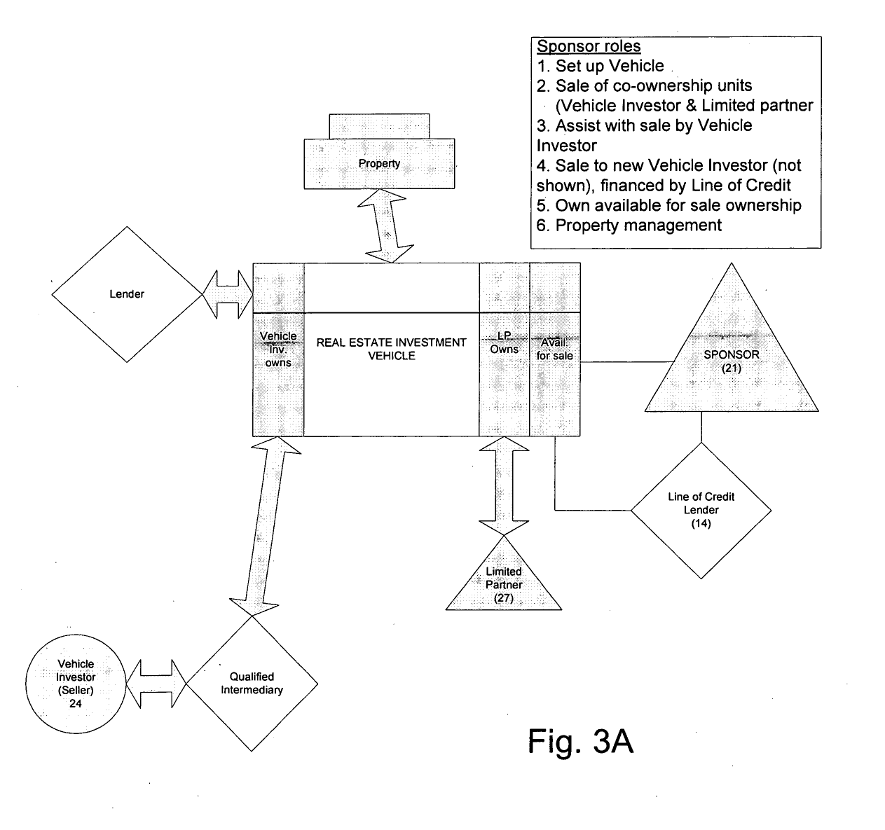

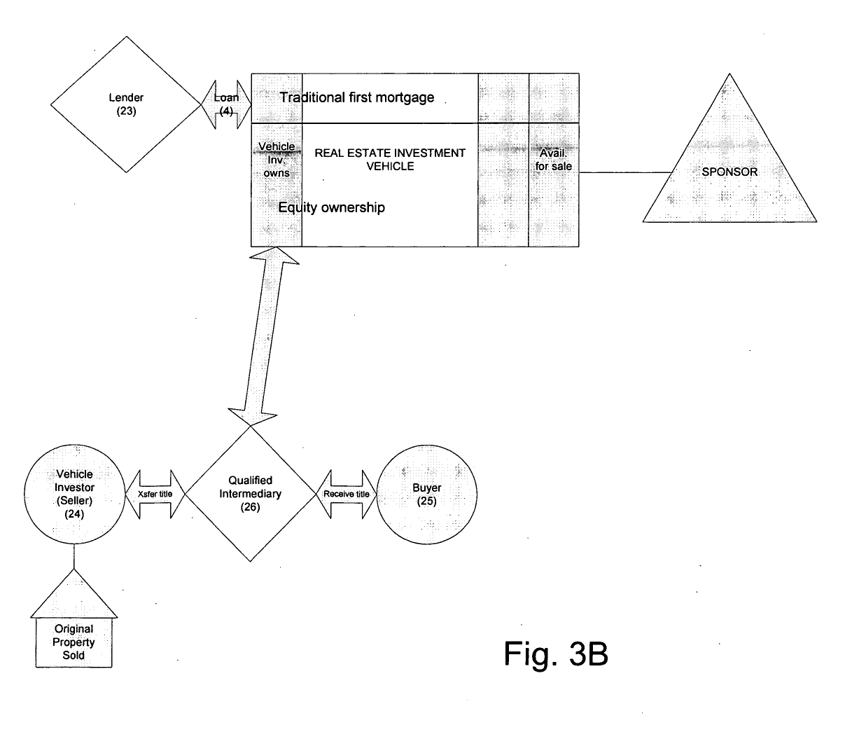

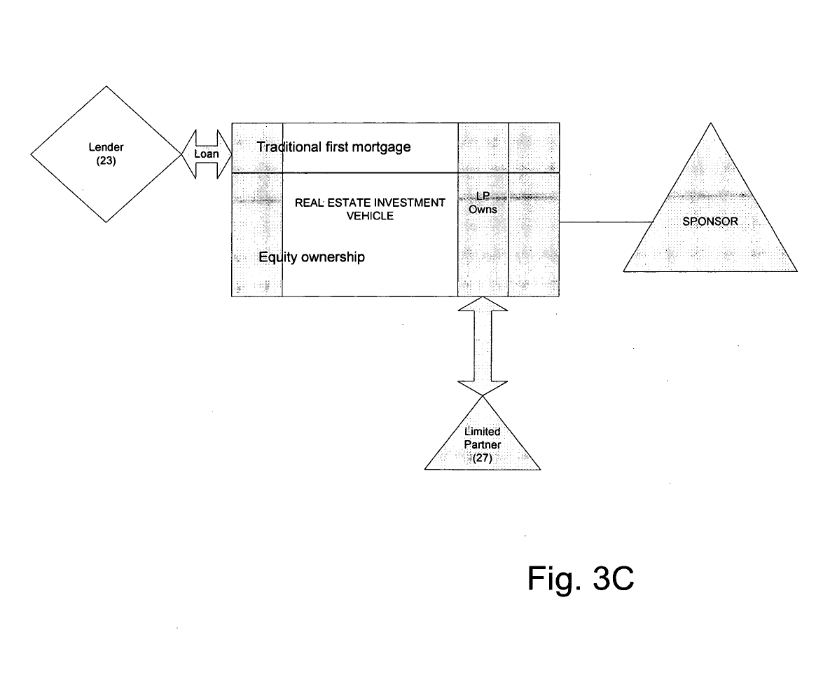

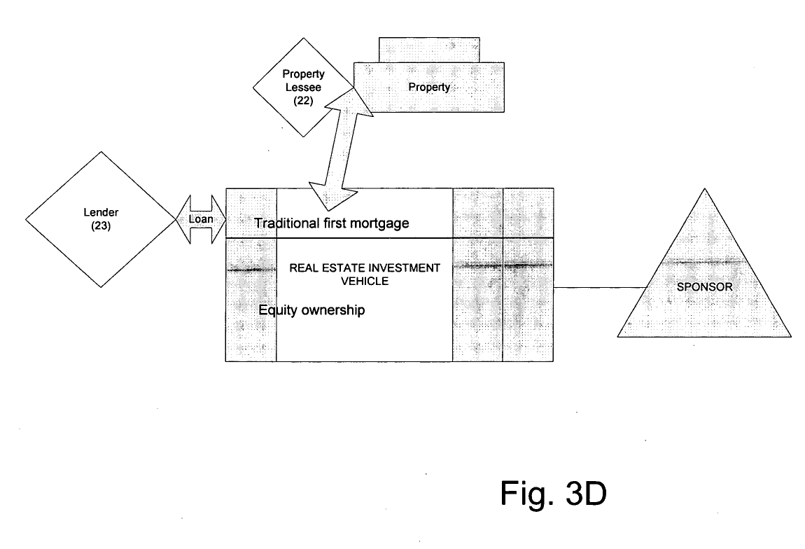

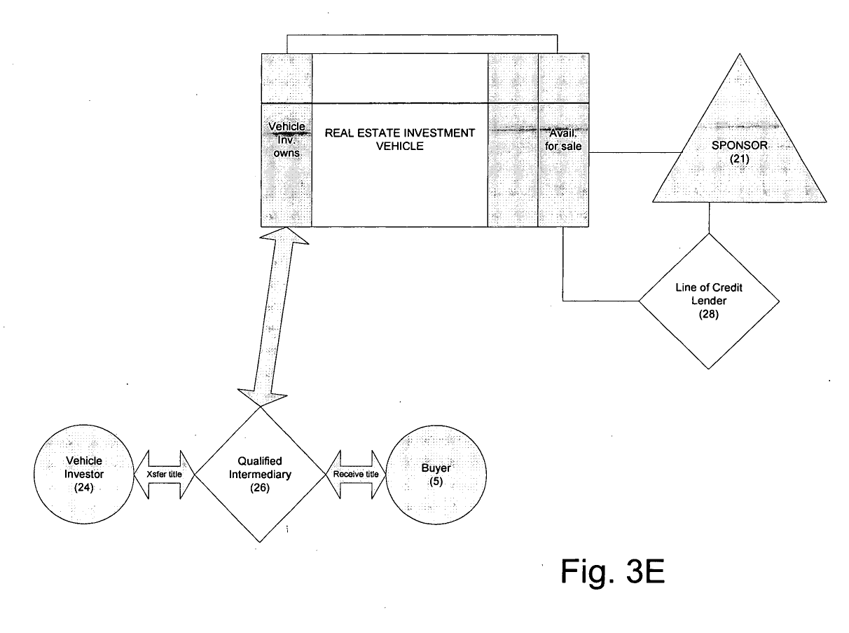

FIGS. 3A-3E illustrate the relationships between the various parties involved in the invention or investment vehicle. These parties consist of the Sponsor, Vehicle Investors, Limited Partners, and Lender(s).

As shown in FIG. 3A, the Sponsor 21 provides overall direction and management of the Vehicle. The structure of the Vehicle is as described in FIG. 2. The Sponsor's 21 roles include initial establishment or setup (11) of the Vehicle and purchase of the real property to be owned by the Vehicle. Co-ownership interests are sold to Vehicle Investors 24 and Limited Partners 27, in exchange for cash payments (12). The Sponsor 21 also assists Trading Investors 24 with sales of their ownership interests in exchange for separate replacement real properties (13). This type of transaction, one aspect of the present invention, is described in more detail with respect to FIG. 5. The sale by a Vehicle Investor may be financed by a line of credit (14) established to provide finding of the sales amount to the Vehicle Investor, pending resale to a new Vehicle Investor. Finally, the Sponsor 21 provides property management services (15) for the property on behalf of the co-owners and tenant.

FIG. 3B illustrates the Vehicle Investor position. The present invention provides for partial ownership of the Vehicle by multiple Vehicle Investors. The diagram illustrates one investor 24, although up to 35 co-owners, in total, may be admitted, under current IRC regulations. Also, as a condition for obtaining tax-deferral for subsequent exchanges, there may be a minimum holding period to comply with applicable provisions of the Internal Revenue Code. A portion of the ownership of the Vehicle may consist from time to time of a fractional interest that is not subscribed or owned by a specific Vehicle Investor, but is available for sale to new Vehicle Investors. First, an investor (Vehicle Investor) 24 seeking to exchange an existing real property for a replacement property in order to defer gains, enters into an agreement with a Buyer 25. The Buyer 25 transfers the amount of the agreed purchase price to a Qualified Intermediary 26, in exchange for title to the Seller's property. The Qualified Intermediary 26 transfers the proceeds of the sale of the property received from Buyer 25 to the Vehicle in exchange for a fractional or co-ownership interest, received by the Trading Investor 24. A series of similar co-ownership interests can be obtained from other Trading Investors.

A portion of the acquisition payment for the TIC Property is financed by a Lender 23, who extends a loan secured by a mortgage on the property. All co-owners are jointly and severally liable for the obligation represented by this loan. The Vehicle Investors would receive periodic distributions of income generated by the Vehicle. This is described in more detail in the pro form a financial statements discussed below.

As illustrated in FIG. 3C, one embodiment of the present invention provides for partial ownership by Limited Partners 27, who are expected to remain co-owners for the entire life of the Vehicle. Such ownership interests for the Limited Partners 27 are obtained upon payment of the appropriate amount into the Vehicle in exchange for their co-ownership interests. A portion of the acquisition payment for the TIC Property is financed by a Lender 23, who extends a loan secured by a mortgage on the property. All co-owners, including the Limited Partners 27, are jointly and severally liable for the obligation represented by this loan.

The Limited Partners 27 receive periodic distributions of income generated by the Vehicle. This is described in more detail in the pro form a financial statements discussed below.

As diagrammed in FIG. 3D, the present invention includes financing arrangements with Lenders 23 providing debt for a portion of the value of the property (or properties) owned by the Vehicle. Such debt is secured by a mortgage or lien against the property(ies). The property owned by the Vehicle is leased to a tenant 22, who makes payments for use of the property. Such lease payments allow for repayment of the loan provided by the Lender 23.

A portion of the ownership in the present invention or Vehicle may be held available for sale to new Vehicle Investors, as illustrated in FIG. 3E. Such ownership interests can be financed under a line of credit established to provide funds to finance or carry the value represented by the ownership interests in the Vehicle held available for sale. This line of credit would be arranged by the Sponsor 21 in connection with the present investment Vehicle. When a Vehicle Investor 24 seeks to exchange their ownership in the Vehicle for a separate replacement property, the Sponsor 21 may repurchase such ownership from the Vehicle Investor 24. The ownership interest received is available for sale to new investors.

The amount needed to pay the Vehicle Investor 24 can be obtained via a loan from the Line of Credit Lender 28, who establishes a credit line for this purpose in connection with the Vehicle. The proceeds of the loan are paid or transferred to a Qualified Intermediary 26, to be held for the benefit of the Trading Investor 24 (in connection with the acquisition of a separate replacement real property, described in more detail in FIG. 5).

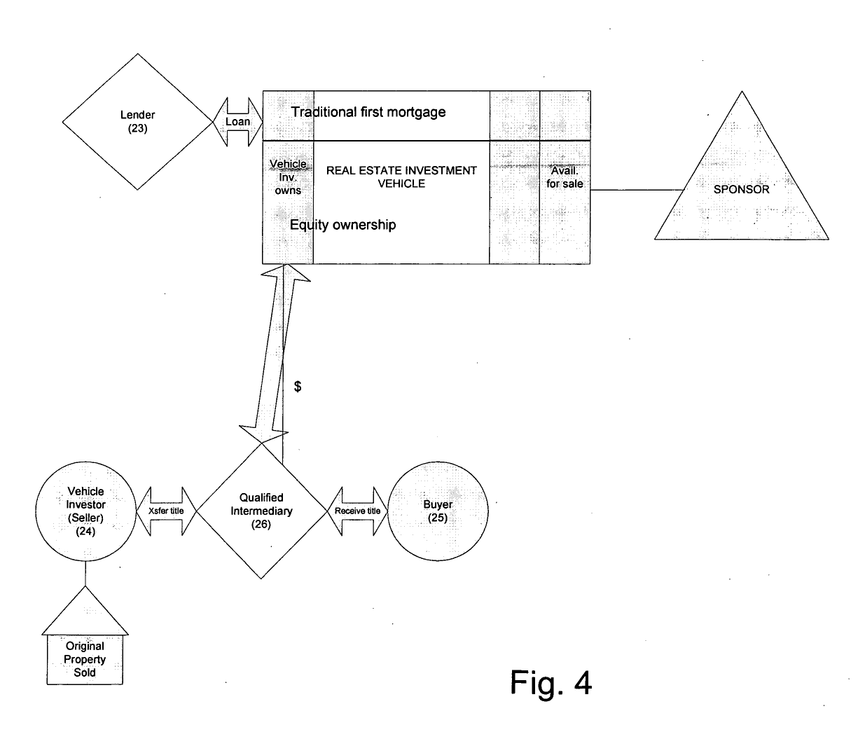

FIG. 4 illustrates the initial acquisition of co-ownership in the Vehicle by a Vehicle Investor. An investor 24 exchanges property for a fractional ownership interest in the vehicle. The present invention provides for partial ownership of the Vehicle by multiple Vehicle Investors. The diagram illustrates one investor, although up to 35 co-owners, in total, may be admitted, under current IRC regulations. A portion of the ownership of the Vehicle may consist from time to time of a fractional interest that is not subscribed or owned by a specific Vehicle Investor, but is available for sale to new Vehicle Investors.

First, an investor (Vehicle Investor) 24 seeking to exchange an existing real property for a replacement property in order to defer gains enters into an agreement with a Buyer 25. The Buyer 25 transfers the amount of the agreed purchase price to a Qualified Intermediary 26, in exchange for title to the Seller's property. The Qualified Intermediary 26 transfers the proceeds of the sale of the property received from Buyer 25 to the Vehicle in exchange for a fractional or co-ownership interest, received by the Trading Investor 24. A series of similar co-ownership interests can be obtained from other Trading Investors.

A portion of the acquisition payment for the TIC Property is financed by a Lender 23, who extends a loan secured by a mortgage on the property. All co-owners are jointly and severally liable for the obligation represented by this loan. The Vehicle Investors 24 receive periodic distributions of income generated by the Vehicle. This is described in more detail in the pro form a financial statements discussed below.

It is anticipated that there will be a strong interest from potential Vehicle Investors in the present invention, due to the unique ability to exchange a co-ownership in the Vehicle for a replacement real property. FIG. 5 illustrates the exit strategy provided by the present invention. The Vehicle Investor 24 identifies a replacement property, and enters into an agreement with the Seller 29 to acquire the property. In connection with this transaction, the Vehicle Investor 24 informs the Sponsor 21 of the Vehicle of its desire to exchange its ownership interest in the Vehicle. Valuation of the exiting Vehicle Investor's interest based upon fair market value at the time of the exchange may be determined utilizing a methodology established for this purpose.

Funding for the acquisition of the Vehicle Investor's interest is obtained by drawing against the Line of Credit established by the LOC Lender 28, with the funds transferred to a Qualified Intermediary 26. The QI 26 holds the funds for the mutual benefit of the Trading Investor 24 and Seller 29 of the replacement property. Payment is made to the Seller 29 upon delivery of title to the Vehicle Investor 24, who will thus obtain ownership of a replacement property, while deferring gains on both the ownership in the Vehicle and original property exchanged for the co-ownership interest in the Vehicle (as long as the conditions of IRC section 1031 are observed).

The co-ownership interest from the exchanging Vehicle Investor is held for resale to new investors. It is anticipated that a portion of the ownership in the Vehicle may be held available for sale at all times, which is one of the significant unique attributes of the present invention.

The co-owners of the Vehicle may be liable for either their pro-rate share of the debt encumbering the property, or may be jointly and severally liable for the debt. In addition, the debt could be structured so as to provide for the assumption of a portion of the financing by new co-owners who buy in subsequent to the initial establishment of the debt secured by the underlying real property.

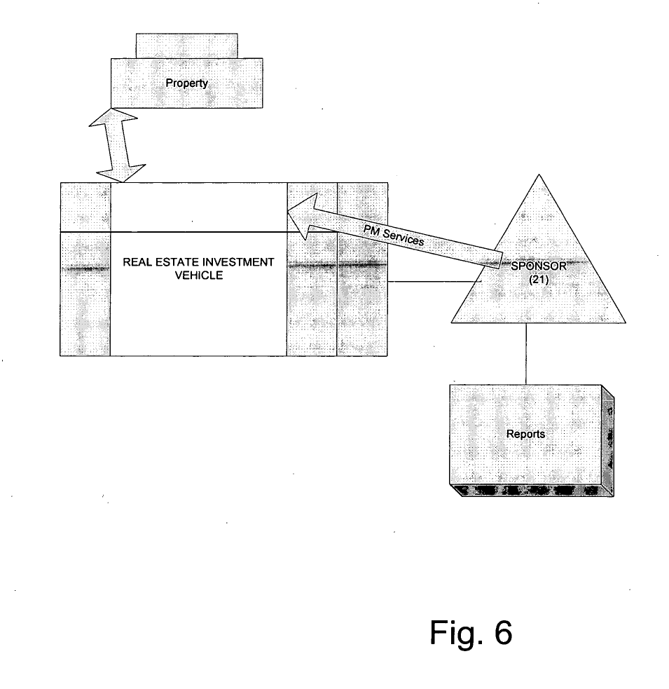

The Sponsor 21 provides property management services with respect to the property owned by the Vehicle, as illustrated in FIG. 6. Initially, the Sponsor 21 arranges for the Tenant 22 to execute a lease for the property. The lease provides periodic rental payments to the Vehicle. In addition, the Tenant 22 may be responsible for payment of taxes, insurance, maintenance, and other direct expenses related to the property, under a so-called triple net lease arrangement.

The Sponsor 21, in its role as Property Manager, prepares and files periodic reports to comply with tax and regulatory requirements, and reports to interested parties as necessary. The Sponsor 21 receives a fee for such services in accordance with customary and reasonable business practices.

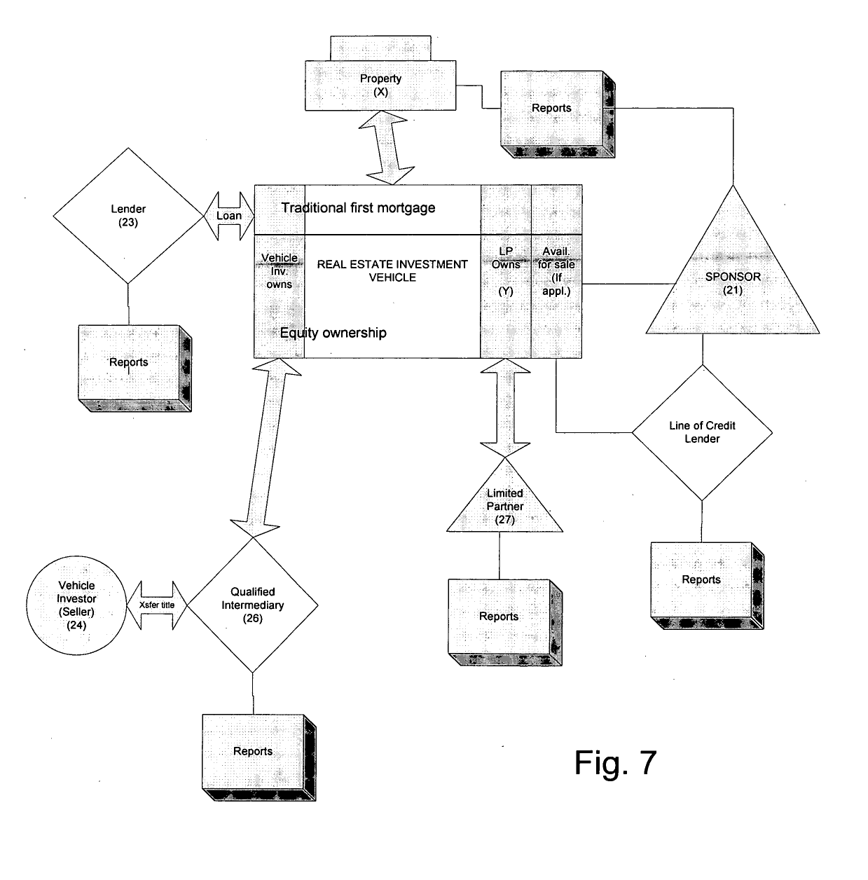

The accounting and record keeping activities associated with the present investment Vehicle may be manage using a computer system. For example, a computer system can be used to manage all of the above activities, utilizing a series of databases, communications systems, and network connections, as shown in FIG. 7.

The reports may include information on the acquisition of co-ownership interests by Vehicle Investors and Limited Partners. Also, reports on the establishment and administration of the Loan for the property may be maintained.

The system may also record and report lease payments from the Tenant to the Vehicle. Property Management activities, as described in FIG. 6, may be managed and recorded by the system. The system could also record and report financial results from the Vehicle on behalf of the co-owners, including Vehicle Investors and Limited Partners. Such reports may include sharing of fees with Limited Partners, as described more fully below in the pro form a financial statements.

Exchanges or sales by Vehicle Investors may also be recorded and reported by the system, in accordance with the methods described in FIG. 5. Related to this, utilization of the Line of Credit can be reported and recorded by the system for administrative and reporting purposes.

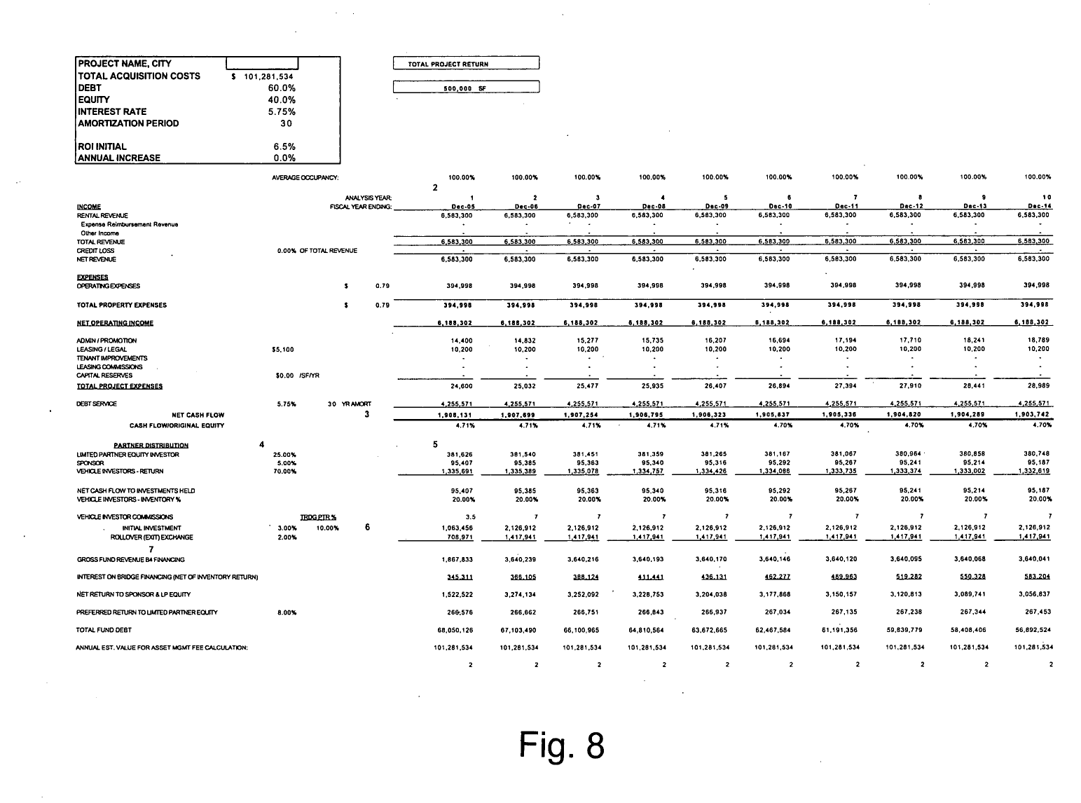

FIGS. 8-10 are sample pro form a statements showing the distribution of income and returns from a hypothetical embodiment of the present invention. These statements illustrate the distribution of income or returns to the participants in the Vehicle, as projected to be achieved by the Vehicle reflecting a particular set of assumptions for a real estate investment project. Note that these pro form a statements are intended to illustrate the concept of the present invention, and reflect assumptions that one skilled in the art will recognize as typical of real estate projects.

Project Return Summary (FIG. 8)

This statement illustrates the total project return in summary form. The Vehicle holds an ownership in a real estate project, with key parameters as shown in section 1. The project generates revenue as shown in section 2 and net cash flows after expenses and debt service as shown in section 3, similar to traditional real estate investments. The total project return is distributed to the investors in the Vehicle in proportion to their level of ownership (section 4), that provides the annual pro form a amounts for each type or class of investor as shown in section 5.

The Project Return summary schedule also illustrates pro form a assumptions regarding revenue from commissions paid by Vehicle Investors from initial and rollover investments (section 6). Finally, the schedule includes calculations (section 7) of returns to the Sponsor and Limited Partners, which are included in other schedules, as described more fully below.

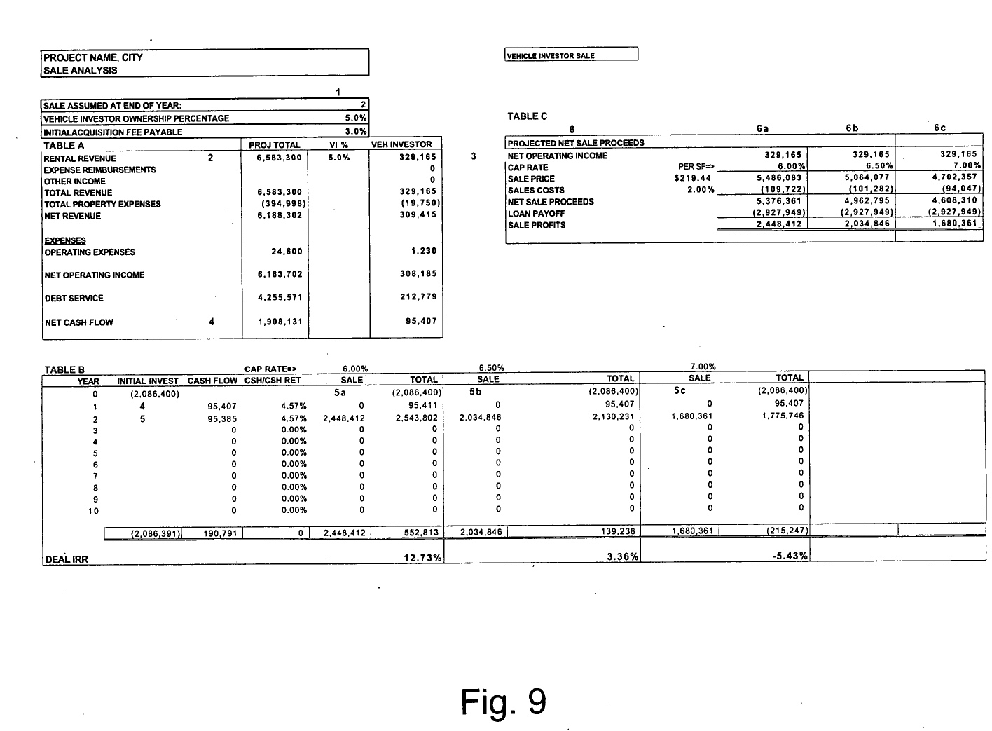

VI Sale—Vehicle Investor Pro Form a Return (FIG. 9)

The Vehicle Investor's pro form a return is expected to consist of two separate components: (1) net cash flow from the annual or ongoing net revenue or cash flow from the project and (2) the proceeds of sale of the investor's ownership interest in the Vehicle, presumably via an exchange for a more desirable real estate investment.

The statement is based on assumptions reflected in section 1 of the Vehicle Investors position representing a holding period prior to a subsequent exchange, ownership level, and initial acquisition fee. From these values and sharing in the project returns set forth in the total Project Return summary (Table A, section 2), one can project a pro form a result as presented in section 3 for the Vehicle Investor's pro-rata share of the project return. The resulting annual net cash flow to the Vehicle Investor is projected in section 4.

Table B shows the projected total return to the Vehicle Investor. This consists of (1) annual net cash flow (from Table A. section 4) and (2) the proceeds of the sale of the investor's ownership. The sale proceeds are presented in sections 5a-c, and are calculated in Table C. That table shows the projected net sale proceeds under varying assumptions for the valuation of the investor's ownership, applying a capitalized income methodology for purposes of the pro form a presentation. The results are presented in sections 6a-c, and carried over to Table B.

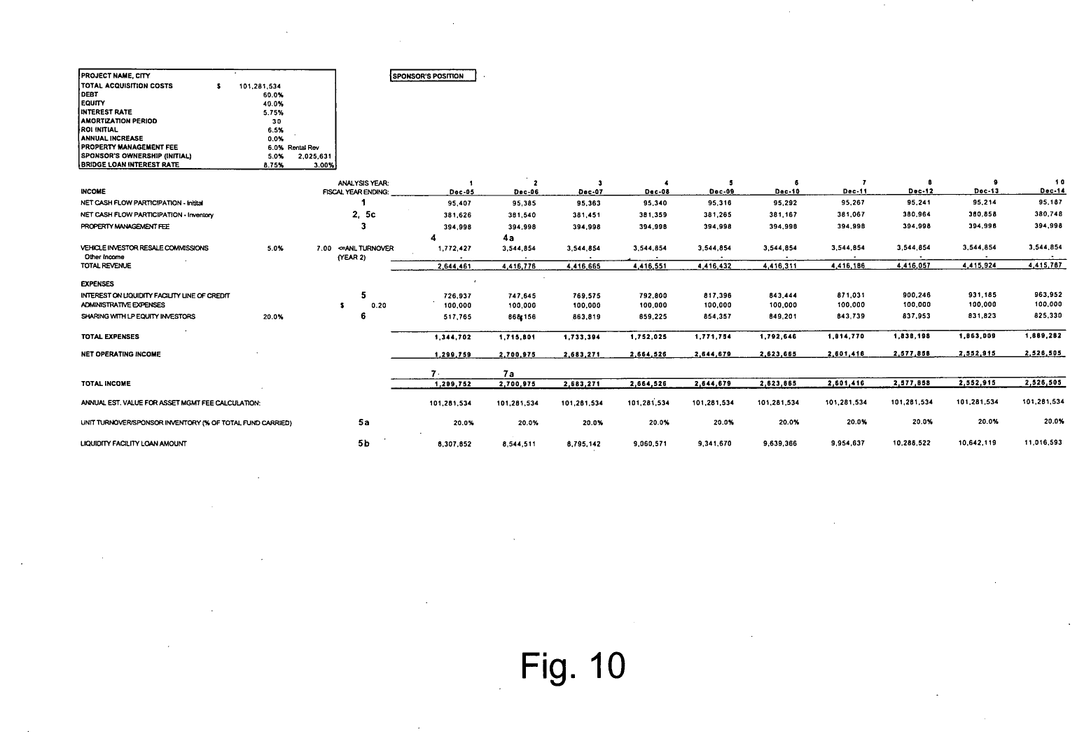

Sponsor's Pro Form a Return & Distribution of Income (FIG. 10)

The Sponsor's role and anticipated return from the Vehicle is presented in this worksheet. This consists of three separate components (1) participation in the ownership of the Vehicle, (2) property management fees, and (3) fees or commissions earned from investments or acquisition of ownership interests by Vehicle Investors and subsequent sales of such ownership interests. The pro form a results also include the impact of the interest expense from the portion of the Vehicle financed as Inventory under the liquidity line of credit and payments made to Limited Partners.

The Sponsor receives net cash flow as shown in section 1 from its ownership of a portion of the Vehicle, on the same basis as other owners. (This is the same amount as reflected in the Project Return Summary, section 5). The sponsor is also projected to receive a property management fee, as shown in section 3.

Fees or commissions to the Sponsor from sales of ownership interests in the pro form a statement are based on the assumptions in section 3, resulting in the amounts in section 4. Commissions are projected to be a percentage of the value of the ownership interest sold or transferred, with commissions generated for both initial purchases by Vehicle Investors and subsequent sales. Such sales are presumed to be related to an exchange for another real estate investment qualifying as a section 1031 exchange, as set forth in the Vehicle Investor's pro forma.

The Sponsor also receives the net cash flow on ownership interests held pending resale, so-called Sponsor Inventory. The pro form a amount of net cash flow from Inventory is reflected in section 2, based on the amount of inventory from section 5a. It is further assumed in the pro form a statement that the ownership interests held as inventory for future sale, from section 5a, are financed under the credit or liquidity facility line of credit established in connection with the Vehicle. The interest on the liquidity facility is reflected in section 5.

Finally, the Vehicle has ownership interests from limited partners, who receive a portion of the fees or commissions from sales of ownership interests by Vehicle investors, as reflected in Section 6. The total income, consisting of all three sources, is reflected in section 7, with 7a reflecting the results in year 2 of the Vehicle's pro form a projections.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. An investment system comprising:
an investment real property, subject to fractional ownership;
an entity sponsor; and
investors having a fractional ownership in the real property;
wherein an investor can exchange another real property interest for an ownership interest in the investment real property such that the exchange qualifies for deferral of taxes on gains, and when an investor wishes to withdraw its ownership interest in the investment real property, the entity sponsor provides a replacement investor, or purchases the investor's ownership interest in the investment real property.

2. The investment system of claim 1, wherein an investor purchases a different real property interest that qualifies for deferral of taxes on gains with proceeds of a sale of an interest in the investment real property.

3. The investment system of claim 1, wherein the investment real property and produces rental income from the property for the benefit of the owners of the investment real property.

4. The investment system of claim 1, wherein the fractional ownership interest is a tenants-in-common (TIC) ownership interest.

5. The investment system of claim 1, wherein a portion of the investment real property is held for sale to new investors throughout the life of the investment system.

6. The investment system of claim 1, wherein an investor must hold an ownership interest in the investment real property for a minimum period of time.

7. The investment system of claim 1, wherein the sponsor establishes a line of credit in order to provide a source of liquidity to purchase an ownership interest of any investor who wishes to sell or exchange an ownership interest in the investment real property for a different real property.

8. The investment system of claim 1, wherein the sponsor earns fees in connection with each acquisition and sales of an ownership interest by an investor in the investment real property.

9. The investment system of claim 1, wherein the investment system has two classes of investors: Vehicle Investors and Limited Partners.

10. The investment system of claim 9, wherein the Limited Partners retain an ownership interest for a duration of the life of the investment system.

11. The investment system of claim 1, wherein the ownership interests in the real property is at least partially financed by debt subject to a mortgage on the real property.

12. The investment system of claim 1, wherein the investment real property comprises multiple, different real estate properties held under common ownership.

13. An investment system comprising:
an investment real property, subject to fractional ownership;
an entity sponsor;
limited partners having an ownership interest in the investment real property; and
investors having an ownership interest in the investment real property, wherein the investors have a tenants-in-common (TIC) ownership interest;
wherein the limited partners have a tenants-in-common ownership interest in the investment real property, and
wherein an investor can exchange another real property interest for an ownership interest in the investment real property such that the exchange qualifies for deferral of taxes on gains, and when an investor wishes to withdraw its ownership interest in the investment real property, the sponsor provides a replacement investor, or purchases the investor's ownership interest in the investment real property.

14. The investment system of claim 13, wherein an investor purchases a different real property interest that qualifies for deferral of taxes on gains with proceeds of a sale of an interest in the investment real property.

15. The investment system of claim 13, wherein the investment real property produces rental income from the property for the benefit of the owners of the investment real property.

16. The investment system of claim 13, wherein a portion of the investment real property is held for sale to new investors throughout the life of the real property.

17. The investment system of claim 13, wherein an investor must hold an ownership interest in the investment real property for a minimum period of time.

18. The investment system of claim 13, wherein the sponsor establishes a line of credit in order to provide a source of liquidity to purchase an ownership interest of any investor who wishes to sell or exchange its ownership interest in the investment real property for a different property.

19. The investment system of claim 13, wherein the ownership interests in the real property is at least partially financed by debt subject to a mortgage on the real property.

20. The investment system of claim 13, wherein the limited partners retain an ownership interest in the investment real property for a duration of the life of the investment system.

21. A real estate investment method comprising:
purchasing investment real property for ownership by investors;
selling fractional ownership interests in the investment real property to investors, wherein an investor can exchange another real property interest for an ownership interest in the investment property such that the exchange qualifies for deferral of taxes on gains; and
providing an exit mechanism for an investor who wishes to withdraw its ownership interest in the investment real property, by providing a replacement investor or purchasing the investor's ownership interest in the investment real property.

22. The method of claim 21, further comprising selling ownership interests to Limited Partners, who retain an ownership interest for a duration of the life of the investment, in order to maintain stability in the investment.

23. The method of claim 21, wherein a portion of the ownership in the investment entity is held for sale to new investors during the life of the investment real property.

24. The method of claim 21, wherein the investment real property comprises two or more real estate properties.
